(19) United States
(12) Patent Application Publication
(10) Pub. No.: US 2023/0331405 A1
(43) Pub. Date: Oct. 19, 2023

(54) MINI FREEZER-EQUIPPED DRONE FOR TRANSPORTING BIOLOGICAL MATERIALS AND METHOD OF USING SAME

(71) Applicants: Ganapathi Pamula, Cary, NC (US); Lakshmi Pamula, Cary, NC (US); Vamsee Pamula, Cary, NC (US)

(72) Inventors: Ganapathi Pamula, Cary, NC (US); Lakshmi Pamula, Cary, NC (US); Vamsee Pamula, Cary, NC (US)

(21) Appl. No.: 18/213,149

(22) Filed: Jun. 22, 2023

Related U.S. Application Data
(63) Continuation-in-part of application No. 17/114,161, filed on Dec. 7, 2020.
(60) Provisional application No. 63/354,266, filed on Jun. 22, 2022.
(60) Provisional application No. 62/944,416, filed on Dec. 6, 2019.

(51) Int. Cl. B64U 10/14; F25D 3/08; F25D 11/00

(52) U.S. Cl. CPC B64U 10/14; F25D 3/08; F25D 11/003; F25D 2303/082; B64U 2101/64

(57) ABSTRACT

According to some embodiments, a freezer-equipped drone for transporting biological materials and method of using same is provided. In some embodiments, a freezer-equipped drone comprises a temperature control device for transporting biological materials, such as, but not limited to, vaccines, blood samples, urine samples, saliva samples, nasal samples, bodily fluids, tissue samples, and the like. For example, a freezer-equipped drone can comprise a drone equipped with a mini freezer for holding biological materials that may be activated to some desired temperature using active cooling mechanisms at the same time of aerial transport.

### CROSS-REFERENCE TO RELATED APPLICATIONS

This application claims the priority benefit under 35 U.S.C. § 119(e) of U.S. Provisional Patent Application No. 63/354,266 filed on Jun. 22, 2022, and is a continuation-in-part of U.S. patent application Ser. No. 17/114,161 filed Dec. 7, 2020, which claims the priority benefit under 35 U.S.C. § 119(e) of U.S. Provisional Patent Application No. 62/944,416 filed on Dec. 6, 2019, the contents of each of which are herein incorporated by reference in their entirety.

### TECHNICAL FIELD

The technology described herein generally relates to drones or unmanned aerial/autonomous vehicles (UAVs), and more particularly to a mini freezer-equipped drone or UAV for transporting biological materials and method of using same.

### BACKGROUND

Drones are increasingly applied in the medical field. With the recent COVID-19 pandemic, last mile delivery of vaccines requiring ultra-cold temperatures have impeded widespread and quick distribution of vaccines. For example, Moderna and Pfizer vaccines require storage temperatures of −25 to −15° C. More than a billion people have no access to all-season roads making it hard to deliver vaccines. Cold chain facilities are almost non-existent in low-income countries. Last mile vaccine delivery costs up to 63.2 times the other total logistic costs in low- and middle-income countries and these costs are primarily made up of labor and cold chain. Consequently, there is a need for inexpensive methods to rapidly transport vaccines and other medicines to hard-to-reach people.

Currently, drones are being deployed for both dropping off and picking up medical supplies. Drones are also deployed to deliver vaccines to remote places. Drones that can keep payloads cold would be highly desirable for delivering vaccines, ice cream, medications, and other perishables. Both passive cooling and active cooling have been demonstrated on drones, but are generally not necessarily capable of achieving ultra-low temperatures suitable for certain payloads.

Drones or conventional drone systems currently carry a box that is passively cooled and temperature controlled. For example, some drones have demonstrated the ability to passively cool down to −20° C. using ice packs, preconditioned ice, phase change materials, and/or dry ice. Some examples include Pfizer-Zipline drones delivering medical supplies in Ghana and now in the U.S.A., drones from Swoop Aero (Port Melbourne, Australia), drones from Merck Pharma (Wilson, NC) and Volansi, Inc. (Concord, CA), and drones from Marut Dronetech Private Limited (Telangana, India). However, these drones and systems cannot reach ultra-cold temperatures, or sub-zero temperatures. Accordingly, the technology described herein provides improvements over conventional drone systems and applications through active cooling mechanisms to reach sub-freezing temperatures, or further the use of aerodynamic features made available during flight for efficient cooling.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are generally directed towards systems, devices, apparatus, and methods of transporting and/or processing temperature-sensitive payloads. In some aspects, a system can include a drone or UAV and a freezer connected to the drone or UAV to transport and/or process a temperature sensitive payload at a desired temperature (e.g. down to about −20° C.) through the use of active temperature control and/or passive temperature control. In some instances, temperature control can be attained through a thermoelectric device utilizing active temperature feedback from a temperature measurement device.

In one embodiment a system for transporting a temperature-sensitive payload is provided, the system comprising a drone comprising a drone body and one or more propellers and a freezer connected to the drone body and configured to contain a payload. In some aspects the internal temperature of the freezer and/or the temperature of the payload is maintained at a desired temperature, such as a sub-zero or sub-freezing temperature.

In some other embodiments, a method of transporting a temperature-sensitive payload is provided, comprising implementing a device or apparatus comprising a drone comprising a drone body and one or more propellers and a freezer connected to the drone body and configured to contain a payload. The method further comprise placing a payload in the freezer, and transporting the drone from a first location to a second location while maintaining a desired temperature within the freezer. The method can further comprise removing the payload, and/or detaching the freezer from the drone.

Additional objects, advantages, and novel features of the technology will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, which are not necessarily drawn to scale, and wherein:

FIG. 1 illustrates a side view of an example of a mini freezer-equipped drone for transporting biological materials, in accordance with some aspects of the technology described herein;

FIG. 2 illustrates a simplified top view and side view, respectively, of an example of the mini freezer in relation to the propellers of the mini freezer-equipped drone, in accordance with some aspects of the technology described herein;

FIG. 3 illustrates a simplified top view and side view, respectively, of an example of the mini freezer in relation to the propellers of the mini freezer-equipped drone, in accordance with some aspects of the technology described herein;

FIG. 4 illustrates a block diagram of an example mini freezer-equipped drone for transporting biological materials, in accordance with some aspects of the technology described herein;

FIG. 5 illustrates a side view of an example mini freezer-equipped drone including active cooling in the form of one or more TECs, in accordance with some aspects of the technology described herein;

FIG. 6 illustrates a side view of an example mini freezer-equipped drone including active cooling in the form of TECs and cooling fans, in accordance with some aspects of the technology described herein;

FIG. 7 illustrates a side view of an example mini freezer-equipped drone including active cooling in the form of multiple TECs and thermally conductive blocks on the hot side connected via thermally conductive wires, in accordance with some aspects of the technology described herein;

FIG. 8 illustrates a perspective view of an example mechanism for increasing the outer surface area of a mini freezer box of a mini freezer-equipped drone, in accordance with some aspects of the technology described herein;

FIG. 9 illustrates a perspective view of an example mini freezer-equipped drone including a mini freezer formed using a heat conductive material, in accordance with some aspects of the technology described herein;

FIG. 10 illustrates a side view of an example mini freezer-equipped drone incorporating both active cooling and passive cooling, in accordance with some aspects of the technology described herein;

FIG. 11 illustrates a side view of an example mini freezer-equipped drone incorporating multiple temperature hybrid cooling, in accordance with some aspects of the technology described herein;

FIG. 12 illustrates a side view of an example configuration of a mini freezer including a heat pipe, in accordance with some aspects of the technology described herein;

FIG. 13 illustrates a side view of an example mini freezer-equipped drone incorporating mechanisms for self-charging, in accordance with some aspects of the technology described herein;

FIG. 14 illustrates a flow diagram of an example method of using a mini freezer-equipped drone for transporting biological materials, in accordance with some aspects of the technology described herein;

FIG. 15 illustrates a side view of an example mini freezer-equipped drone for transporting biological materials where the mini-freezer includes a sample processing unit (SPU), in accordance with some aspects of the technology described herein; and

FIG. 16 illustrates a perspective view of an example SPU for use in a mini freezer-equipped drone for both transporting and processing biological material(s), in accordance with some aspects of the technology described herein.

### DETAILED DESCRIPTION

The subject matter described herein can be understood more readily with reference to the following detailed description, examples, and accompanying drawings, in which some, but not all embodiments of the subject matter are shown. It will be appreciated that like numbers refer to like elements throughout. The subject matter may be embodied in many different forms and should not be construed as limited to the embodiments set forth herein; rather, these embodiments are provided so that this disclosure will satisfy applicable legal requirements. Accordingly, elements, apparatus, systems, devices, and methods described herein are not limited to the specific embodiments presented in the detailed description, examples, and figures. It should be recognized that the exemplary embodiments herein are merely illustrative of the principles of the invention. Numerous modifications and adaptations will be readily apparent to those of skill in the art. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Moreover, although the terms “step” and/or “block” can be used herein to connote different elements of methods employed, the terms should not be interpreted as implying any particular order among or between various steps disclosed herein unless and except when the order of individual steps is explicitly described.

At a high level, embodiments of the present technology are generally directed towards systems, devices, apparatus, and methods of transporting and/or processing temperature-sensitive payloads. In some aspects, a system can include a drone or UAV and a freezer connected to the drone or UAV to transport and/or process a temperature sensitive payload at a desired temperature (e.g. down to about −20° C.) through the use of active temperature control and/or passive temperature control. Active and/or passive temperature control can be provided through one or more deices mechanisms. In some instances, temperature control can be attained through a thermoelectric device utilizing active temperature feedback from a temperature measurement device. In one aspect, as system, apparatus, or device for transporting a temperature-sensitive payload comprises drone comprising a drone body and one or more propellers and a freezer connected to the drone body and configured to contain a payload. In some instances, the freezer is configured to maintain an internal temperature of down to −20° C. In some instances, the freezer is configured to maintain the internal temperature through active temperature control. In some instances, a temperature measurement device configured to provide active temperature feedback of the freezer, or an internal temperature of the freezer. In some instances, one or more thermoelectric devices are disposed on at least one side of the freezer. In some instances, a thermoelectric device can be at least one of a thermoelectric heatsink, a thermoelectric fan or cooling fan, and/or one or more thermally conductive wires. As will be appreciated the system can comprise one or more active cooling mechanisms and/or one or more passive cooling mechanisms. In some instances, one or more sides of the freezer may be maximized. In some instances, the freezer can be any shape not inconsistent with the objectives of the present disclosure, for instance the freezer can have six or more sides. In some other instances, the freezer can be configured as a sphere. In some instances, a system can comprise a battery, which may be selected based on at least one of desired temperature, flight duration, and weight carrying capacity. In some instances, the system can comprise two or more batteries, e.g. a battery to power the drone, and a battery to power the freezer.

According to embodiments of the present technology, a freezer or mini freezer-equipped drone is provided for transporting temperature sensitive materials, such as biological materials, and methods of using same.

In some embodiments, the mini freezer-equipped drone and method comprise a drone (also referred to herein as an autonomous multicopter, unmanned aerial vehicle (UAV), autonomous multicopter drone) that carp be equipped with a temperature control device and can be used for transporting temperature sensitive and/or biological materials, such as, but not limited to, vaccines, blood samples, urine samples, saliva samples, nasal samples, bodily fluids, tissue samples, and the like.

According to some embodiments, a mini freezer-equipped drone and method comprise a drone equipped with a mini freezer for holding and/or storing biological materials that can be activated to some desired temperature (e.g. a freezing or sub-freezing temperature) using active cooling mechanisms at the same time of aerial transport, that is during the operation of the drone or UAV.

In some embodiments, the mini freezer-equipped drone and method provide a mini freezer for holding ice cream and other perishables that need to be actively controlled to maintain specific temperatures below freezing.

In some embodiments, a mini freezer-equipped drone and method comprise a freezer or mini freezer for holding biological materials and can include one or more active cooling mechanisms as well as, in some instances, use one or more aerodynamic features available during flight or while in operation, such as the downdrafts from propellers (e.g. drone propellers) and/or other air drafts from flight.

In some embodiments, a mini freezer-equipped drone and method comprise a mini freezer for holding biological materials that can be activated to some desired temperature using one or more active cooling mechanisms and/or passive cooling mechanisms at the same time of aerial transport or when the drone is in operation, for example during flight.

In some embodiments, a mini freezer-equipped drone and method comprise a mini freezer for holding and/or storing biological materials and can include one or more active cooling mechanisms, such as thermoelectric coolers (TECs) including heatsinks and cooling fans.

In some embodiments, a mini freezer-equipped drone and method comprise a mini freezer for holding and/or storing biological materials and can include one or more active cooling mechanisms, such as thermoelectric coolers (TECs) including heatsinks and/or cooling fans and/or one or more passive cooling mechanisms such as ice packs, preconditioned ice, phase change materials, dry ice, other heatsinks not related to TECs, and the like.

In some embodiments, a mini freezer-equipped drone and method comprise a mini freezer for holding and/or storing temperature-sensitive and/or biological materials where the freezer or mini freezer can be activated to some desired temperature, such as from about 2° C. to about 8° C. in one example or from about −15° C. to −10° C. or from about −10° C. to −5° C. or from about −5° C. to 0° C. or from about −25° C. to about −15° C. in another example or at about −20° C. in yet another example. In some instances, a drone equipped with a mini freezer can be activated such that the mini freezer can achieve a temperature (e.g. internal temperature) of from about −20° C. to about 20° C., from about −25° C. to about 8° C., from about −25° C. to about 0° C.

In some embodiments, a mini freezer-equipped drone and method comprise a sample processing unit (SPU) installed inside or within the mini freezer such that the mini freezer-equipped drone can both transport and/or process biological materials or temperature-sensitive materials.

Further, a method of using or employing a mini freezer-equipped drone for transporting biological materials is provided. In some instances, a drone is equipped with a mini freezer that can be activated to a desired temperature or temperature range (e.g. a temperature range can be maintained)

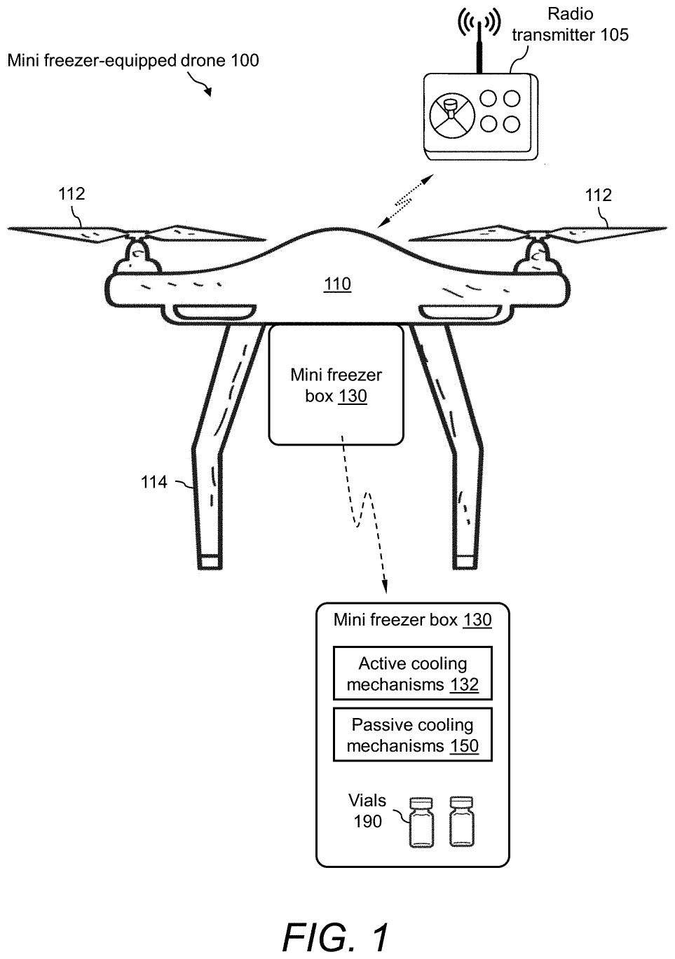

Turning now to the figures, and with reference to FIG. 1 a side view of an example mini freezer-equipped drone 100 for transporting biological materials is illustrated, in accordance with an embodiment of the disclosure. Generally, mini freezer-equipped drone 100 comprises a drone equipped with a temperature control device for transporting a payload, for instance biological materials or temperature-sensitive materials, medications, and other perishables (e.g. ice cream). Biological materials may include, but are not limited to, vaccines, blood samples, urine samples, saliva samples, nasal samples, bodily fluids, tissue samples, and the like. In some embodiments, mini freezer-equipped drone 100 may include one or more active cooling mechanisms. In other embodiments, mini freezer-equipped drone 100 may include both active cooling mechanisms and one or more passive cooling mechanisms.

Further, mini freezer-equipped drone 100 can provide efficient active cooling of a payload down to about −25° C. using thermoelectric cooling and unique aerodynamic features available during flight.

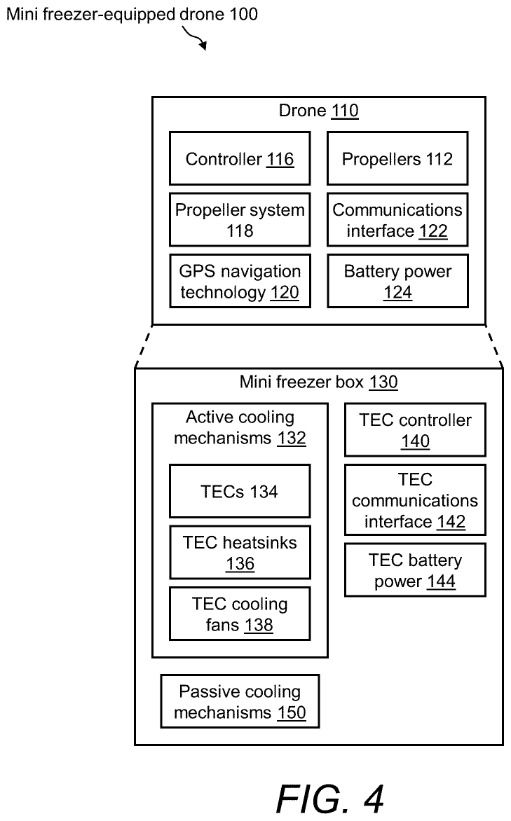

With respect to the various flight aspects of the described technology, mini freezer-equipped drone 100 may include a drone 110 that may include a configuration of propellers 112 (e.g., a configuration of four propellers 112) and landing gear 114 (e.g., four legs). Landing gear 114 can support mini freezer-equipped drone 100 when not in flight. As will be appreciated, drone 110 shown in FIG. 1 is for illustrative purposes only. Drone 110 may include, for example, any single-rotor drones, multi-rotor drones, helicopter drones, fixed-wing drones, fixed-wing hybrid drones, small drones, micro drones, tactical drones, medium drones, large drones, reconnaissance drones, delivery drones, alternative-powered drones, and other winged and rotor drones. Further, a radio transmitter 105 can be provided for operating mini freezer-equipped drone 100 via radio control. The radio transmitter 105 may be, for example, a multi-channel radio transmitter with standard controls as well as any customized controls/interfaces for operating mini freezer-equipped drone 100. Additionally, in place of or in addition to radio transmitter 105, a smartphone (not shown) or any smart device that includes a mobile app (not shown) may be used to control and/or communicate with mini freezer-equipped drone 100, e.g. via one or more radio transmitters, or wireless transmitters. More details of other components of drone 110 are shown and described below with reference to FIG. 4.

Turning back to FIG. 1, with respect to the various cooling aspects of the technology described herein, mini freezer-equipped drone 100 can include a freezer box or mini freezer box 130 for holding, storing, or containing one or more vials 190 and wherein the vials 190 can hold any types of biological materials or temperature-sensitive materials, such as, but not limited to, vaccines, reagents, blood samples, urine samples, saliva samples, nasal samples, bodily fluids, tissue samples, and the like.

Mini freezer box 130 generally is capable of or configured to provide zero or sub-zero temperatures (e.g. sub-zero internal temperatures), or sub-freezing temperatures, and can in some instances take into account ambient outside temperatures. For example, certain vaccines or materials may require storage temperatures of about −25° C. to about −15° C. Accordingly, in one example, mini freezer box 130 can include one or more active cooling mechanisms 132. In some examples, active cooling mechanisms 132 can achieve temperatures of, for example, from about −25° C. to about −15° C. Active cooling mechanisms 132 can use, for example, thermoelectric cooling. As will be appreciated, thermoelectric cooling uses the Peltier effect to create or generate a heat flux at the junction of two different types of materials. A Peltier cooler, heater, and/or thermoelectric heat pump is a solid-state active heat pump which transfers heat from one side of the device to the other, with consumption of electrical energy, depending on the direction of the current. Such an instrument may also be called a Peltier device, Peltier heat pump, Peltier heatsink, solid state refrigerator, or thermoelectric cooler (TEC). In some other examples, mini freezer box 130 can include one or more passive cooling mechanisms 150 that can achieve temperatures down to about −20° C. but without any active control specific temperatures cannot be maintained due to lack of closed loop feedback control and also passive cooling will only last as long as the phase change material lasts. As such, in some embodiments, temperature control is attained through the use of a thermoelectric material and incorporating active feedback from a temperature measurement device (e.g. thermistor, thermocouple, etc.)

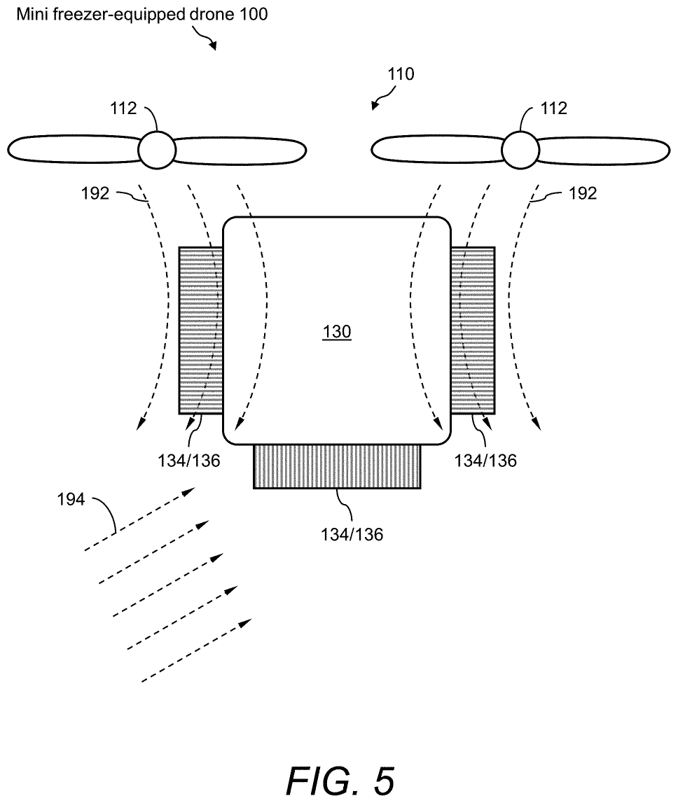

While in some examples, mini freezer box 130 can include one or more active cooling mechanisms 132 only, in some other examples, mini freezer box 130 can include both one or more active cooling mechanisms 132 and one or more passive cooling mechanisms 150. Examples of passive cooling mechanisms 150 may include, but are not limited to, ice packs, preconditioned ice, phase change materials, dry ice, and the like. Other components of mini freezer box 130 are shown and described below with reference to FIG. 4. Further, examples of active cooling mechanisms 132 and/or passive cooling mechanisms 150 are shown and described below with reference to FIG. 5 through FIG. 12.

In some instances, mini freezer box 130 can be separated or otherwise detached or uncoupled from drone 110 at, for example, a healthcare delivery center (for example, one that does not have independent cold storage capabilities) to maintain low temperature of a payload. When disconnected from drone 110, mini freezer box 130 may be powered through a battery delivered by the drone, grid, solar or other sources of energy. In some instances, mini freezer box can have connectivity and/or power capabilities, or further can incorporate a battery or other source of power.

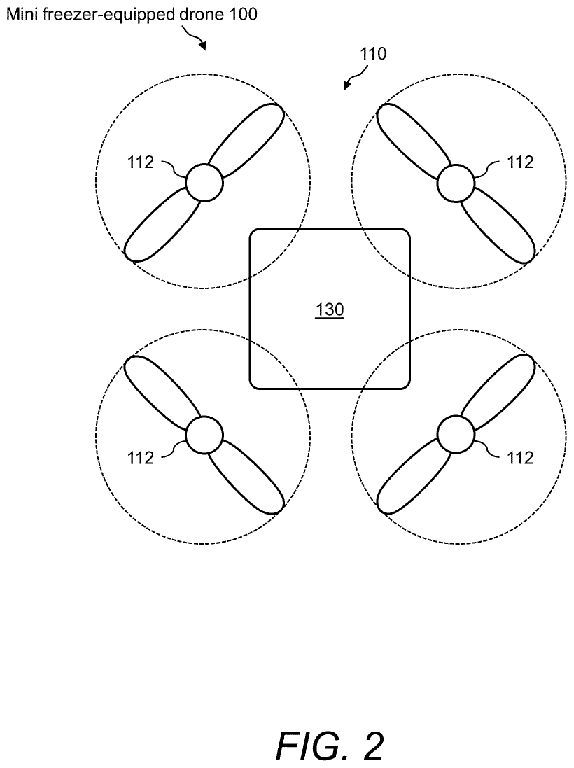

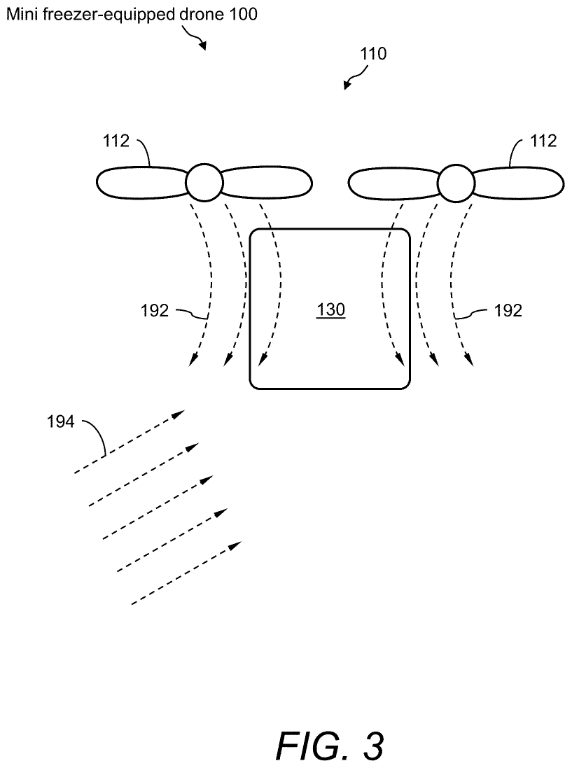

Referring now to FIG. 2 and FIG. 3 a simplified top view and side view are illustrated, respectively, of an example of mini freezer box 130 in relation to propellers 112 of mini freezer-equipped drone 100, in accordance with some embodiments of the present technology. In particular, FIG. 3 shows an example of propeller air drafts 192 (i.e., downdrafts) from propellers 112 that are or can be directed toward mini freezer box 130. Further, mini freezer box 130 can experience winds 194 due to the flight action of mini freezer-equipped drone 100. As will be appreciated, a distance between a propeller of the drone and a side of the freezer box may be selected to maximize passive heat removal.

Referring now to FIG. 4 is a block diagram of an example mini freezer-equipped drone 100 for transporting biological materials or temperature-sensitive materials, in accordance with an embodiment of the disclosure. In this example, drone 110 can further include a controller 116, a propeller system 118 including motors (not shown) for driving propellers 112, Global Positioning System (GPS) navigation technology 120, a communications interface 122, and certain battery power 124 (e.g., any rechargeable or non-rechargeable batteries or combinations thereof). Battery power 124 may be used to power any active components of drone 110.

Controller 116 of drone 110 may be used to manage the overall operations of mini freezer-equipped drone 100. Controller 116 may be any standard controller or microprocessor device that is capable of executing program instructions. A certain amount of data storage (not shown) may be associated with controller 116.

Drone 110 can further include GPS navigation technology 120 which may include any device that can determine its geographical location to a certain degree of accuracy. Accordingly, mini freezer-equipped drone 100 is a geo-enabled drone. For example, GPS navigation technology 120 may include a GPS receiver, such as a global navigation satellite system (GNSS) receiver. A GPS receiver may provide, for example, any standard format data stream, such as a National Marine Electronics Association (NMEA) data stream. GPS navigation technology 120 may also include an error correction component (not shown), which may be any mechanism for improving the accuracy of the geo-location data. In another embodiment, GPS navigation technology 120 may include any device or mechanism that may determine location by any other means, such as by performing triangulation (e.g., triangulation using cellular radiotelephone towers).

Communications interface 122 of drone 110 may be any wired and/or wireless communication interface for connecting to a network (not shown) and by which information may be exchanged with other devices connected to the network. In one example, communications interface 122 may be used to communicate wirelessly with radio transmitter 105 and/or any computer equipped with radio telemetry transceivers (not shown). Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), cellular networks, any combinations thereof, and other types of wireless networking protocols.

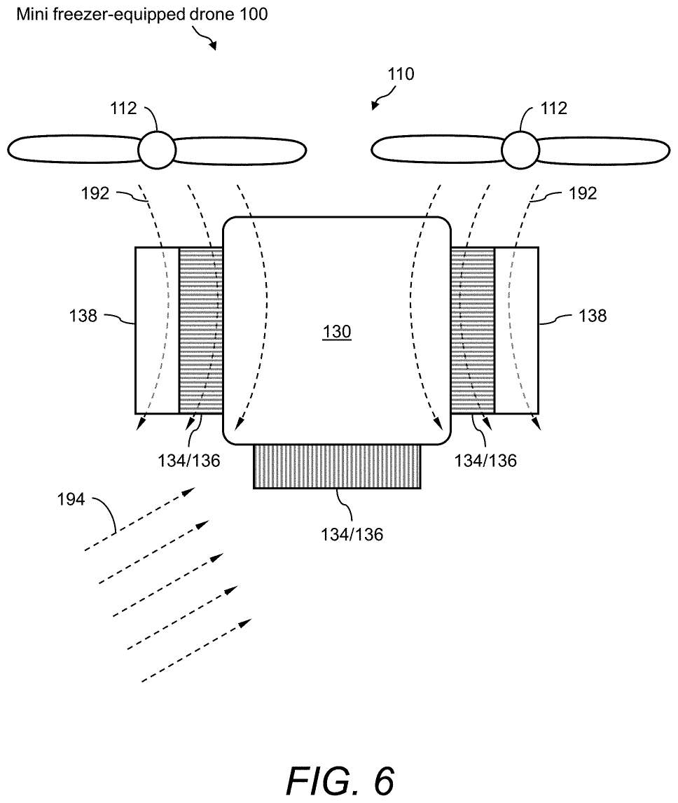

Referring still to FIG. 4, active cooling mechanisms 132 of mini freezer box 130 may further include one or more thermoelectric coolers (TECs) 134. Further, TEC heatsinks 136 and TEC cooling fans 138 may be associated with TECs 134. TEC cooling fans 138 may be any direct current (DC) powered cooling fans that may be fitted to any TEC 134 (see FIG. 6). Mini freezer box 130 may further include a TEC controller 140, a TEC communications interface 142, and certain TEC battery power 144 (e.g., any rechargeable or non-rechargeable batteries or combinations thereof). TEC battery power 144 may be used to power any active components of mini freezer box 130.

Additionally, passive cooling mechanisms 150 of mini freezer box 130 may include, but are not limited to, ice packs, preconditioned ice, phase change materials, dry ice, other heatsinks (not shown) not related to TECs 134, propeller air drafts 192 (i.e., downdrafts) from propellers 112, any other air drafts, wind, airflow caused by flight, and the like.

Each of the TECs 134 can operate according to the Peltier effect. As is well known, the Peltier effect creates a temperature difference by transferring heat between two electrical junctions. A DC voltage is applied across joined conductors to create an electric current. When the current flows through the junctions of the two conductors, heat is removed at one junction and cooling occurs. Heat is deposited at the other junction.

In mini freezer box 130, a TEC heatsink 136 is required to dissipate heat away from the hot side of the TEC 134. Normally, a heatsink has fins made of high thermal conductivity materials, such as aluminum and other metals. These fins increase the surface area to dissipate heat efficiently. Various types of heatsinks are aluminum heatsink, copper heatsink, solid metal heatsink, pumped liquid heatsink, machined heatsink, forged and diecast heatsink, zipper fin heatsink, skived fin heatsink, bonded heatsink, and extruded heatsink. Optionally, a TEC cooling fan 138 may be attached to the hot side of TEC 134 to quickly remove heat through forced air convection. Sometimes liquid heat pipes are also engaged to remove heat away from the hot side. In order to maintain a low temperature on the cold side of the TEC 134, the hot side also should be commensurately low because a TEC has a fixed temperature differential. In mini freezer-equipped drone 100, various ways are provided to reduce the temperature on the hot side of the TECs 134 by, for example, using the drone flying mechanisms and the air flow patterns that become available during flight. As will be appreciated, various configurations of devices and/or mechanisms can contribute to maintaining a desired temperature within the freezer, of the payload, and further in the aspects of passive cooling mechanisms, drone features (e.g. propellers) and freezer dimensions (e.g. maximized side(s)) may contribute to quick and efficient heat removal and temperature control.

TEC controller 140 may be used to manage the overall operations of mini freezer box 130. TEC controller 140 may be any standard controller or microprocessor device that is capable of executing program instructions. In one example, TEC controller 140 may be an onboard computer, such as a Raspberry Pi (i.e., Raspberry Pi 3 platform available from The Raspberry Pi Foundation (United Kingdom)), or any microcontroller or an application specific circuit board. A certain amount of data storage (not shown) may be associated with TEC controller 140.

TEC communications interface 142 of mini freezer box 130 may be any wired and/or wireless communication interface for connecting to a network (not shown) and by which information may be exchanged with other devices connected to the network. In one example, TEC communications interface 142 may be used to communicate wirelessly with radio transmitter 105 and/or any computer equipped with radio telemetry transceivers (not shown) or with the main microprocessor on the drone to maintain active temperature control through closed loop feedback. Examples of wired communication interfaces may include, but are not limited to I2C protocols, SPI protocols, and UART protocols through USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), cellular networks, any combinations thereof, and other types of wireless networking protocols.

In some embodiments, mini freezer box 130 may be absent TEC controller 140 and TEC communications interface 142. In this example, controller 116 and communications interface 122 of drone 110 may be used for supporting both drone 110 and mini freezer box 130. Further, in some embodiments, mini freezer box 130 may be absent TEC battery power 144. In this example, battery power 124 of drone 110 may be used to power both drone 110 and mini freezer box 130.

Referring now to FIG. 5, a side view of an example mini freezer-equipped drone 100 is illustrated including active cooling mechanisms 132 in the form of one or more TECs 134 is illustrated, in accordance with an embodiment of the disclosure. For example, a TEC 134 may be installed on any panel that forms mini freezer box 130. That is, a TEC 134 may be installed on the side panels, the top panel, and/or the bottom panel of mini freezer box 130, In the example shown in FIG. 5, mini freezer box 130 includes three TECs 134 with their TEC heatsinks 136. One TEC 134 on each of the two side panels and one TEC 134 on the bottom panel of mini freezer box 130. Further, FIG. 5 shows the interaction of propeller air drafts 192 (i.e., downdrafts) from propellers 112 and winds 194 with mini freezer box 130.

In this example, using mini freezer-equipped drone 100, the propeller air drafts 192 generated by the propellers 112 on drone 110 are directed towards the TEC heatsink 136 of TEC 134 to enhance cooling without requiring an inbuilt TEC cooling fan 138 with TEC heatsink 136. An example of TECs 134 including TEC cooling fans 138 is shown in FIG. 6. However, the configuration in FIG. 5 avoids the power consumption and weight of TEC cooling fans 138. Propellers 112 of drone 110 for cooling enables an additional payload weight because is eliminates the weight and energy requirements of TEC cooling fan 138. For propeller air drafts 192 to provide cooling air, they have to be sufficiently close (e.g. within about 12 inches) to TEC heatsinks 136 of TECs 134. The winds 194 just achieved with flight can also remove heat from TEC heatsinks 136 if drone 110 is flying at a sufficient speed (>1 mile/hr). The fins of TEC heatsinks 136 may be arranged horizontal. However, there can be multiple fin arrangements, such as pillars, posts, vertical grooves, horizontal grooves and so on to maximize air flow for removal of heat.

Referring now to FIG. 6, a side view of an example of mini freezer-equipped drone 100 is illustrated including active cooling mechanisms 132 in the form of both TECs 134 and TEC cooling fans 138, in accordance with an embodiment of the disclosure. The configuration shown in FIG. 6 is substantially the same as the configuration shown in FIG. 5 except for the addition of the TEC cooling fans 138.

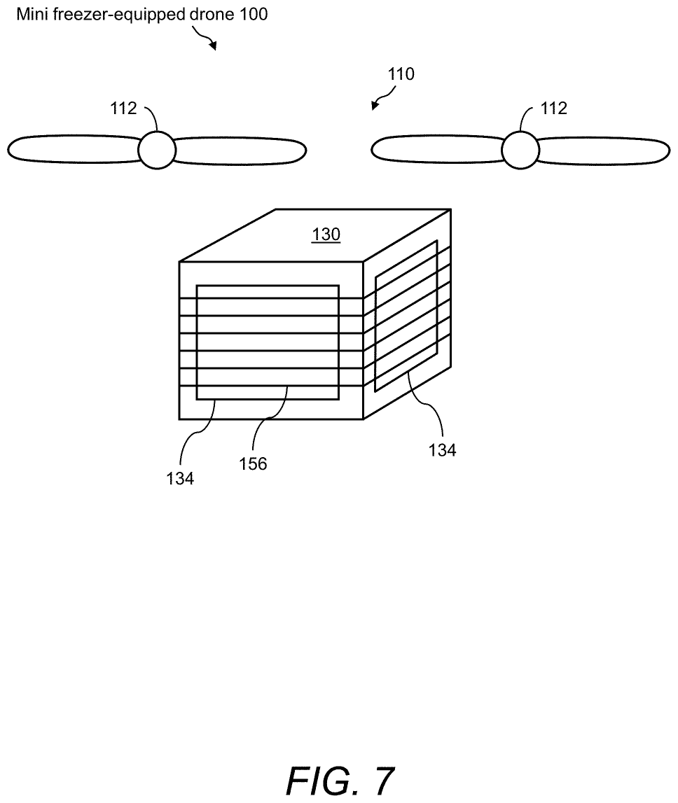

Referring now to FIG. 7 a side view of an example of mini freezer-equipped drone 100 is illustrated including active cooling mechanisms 132 in the form of multiple TECs 134 connected via an arrangement of thermally conductive wires 156, in accordance with an embodiment of the disclosure. The configuration shown in FIG. 7 is substantially the same as the configuration shown in FIG. 5 except for the addition of the thermally conductive wires 156.

As will be appreciated, maximizing heat removal from TEC heatsinks 136 without requiring an active fan eliminates the energy and weight requirements of TEC cooling fans 138. In this example, multiple TEC heatsinks 136 are placed around mini freezer box 130 that is cooled by multiple TECs 134. These TEC heatsinks 136 can be connected by thermally conductive wires 156 or solid/liquid heat pipes or a combination thereof. Thermally conductive wires 156 may have multiple strands to maximize heat dissipation. The flow of air both due to the flight (e.g. winds 194) of the drone and/or the drone propellers (e.g. propeller air drafts 192) may be utilized to remove heat from TEC heatsinks 136. In some example embodiments, mini freezer box 130 may have one or more TECs 134 on each of the six faces to provide uniform coverage of cold temperatures around the entire inner cooling chamber as opposed to placing only on one side of mini freezer box 130. The weight will only slightly increase and current draw can be managed to not increase commensurately. As will be appreciated, one or more TECs 134 can be disposed on any number of sides of the mini freezer box 130.

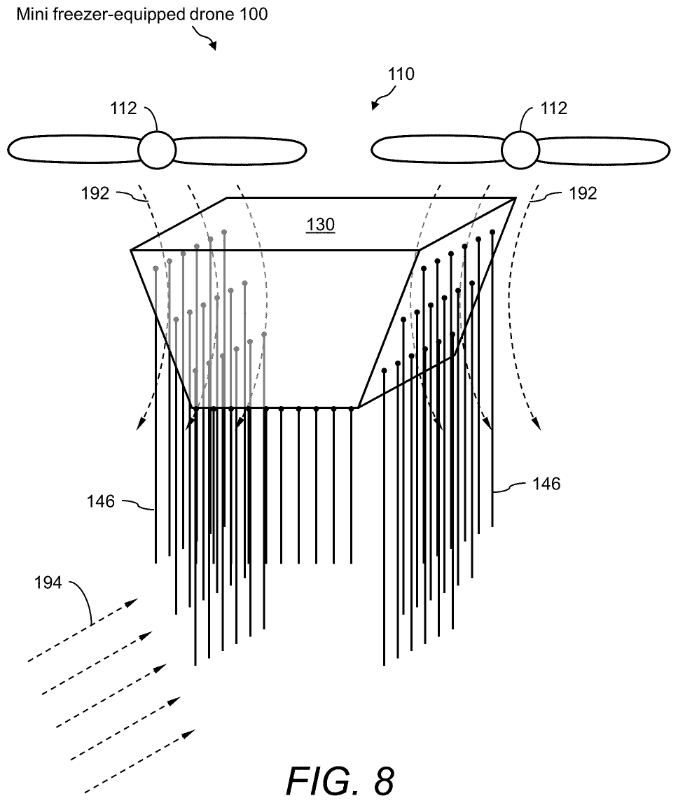

While FIG. 5, FIG. 6, and FIG. 7 show examples of a mini freezer-equipped drone 100 that include one or more active cooling mechanisms 132, FIG. 8 through FIG. 12 show examples of mini freezer-equipped drone 100 that may include both one or more active cooling mechanisms 132 and/or one or more passive cooling mechanisms 150.

Referring now to FIG. 8 is a perspective view of example mechanisms for increasing the outer surface area of mini freezer box 130 of mini freezer-equipped drone 100, in accordance with an embodiment of the disclosure. In this example, instead of a substantially square or rectangular mini freezer box 130, mini freezer box 130 may include tapered sides allowing for an expanded top surface. Further, an arrangement of heat dissipating wires 146 may be installed on any of the side and bottom surfaces of mini freezer box 130. For example, each of the heat dissipating wires 146 may be installed in a hanging fashion or formation. Propeller air drafts 192 (i.e., downdrafts) from propellers 112 and winds 194 may interact with heat dissipating wires 146 to assist in removing heat from the hot side of one or more TECs 134 (not shown).

More specifically, propeller air drafts 192 (i.e., downdrafts) from propellers 112 on drone 110 and winds 194 (e.g., headwinds or tailwinds) on drone 110 are utilized. The arrangement of heat dissipating wires 146 allows air flow in all directions. Moreover, the side walls of mini freezer box 130 are slanting so that thermally conducting material (such as, but not limited to, wires, heat pipes, liquid pipes etc) can be hung from mini freezer box 130 without overlapping with each other to maximize removal of heat. Because drone 110 will be in the air, these thermally conducting and heat dissipating wires 146 may be flexible and may be longer than the length of the drone landing gear 114 and hang from drone 110 when it takes off. This arrangement allows cooling by propeller air drafts 192 and winds 194 (e.g., headwinds or tailwinds).

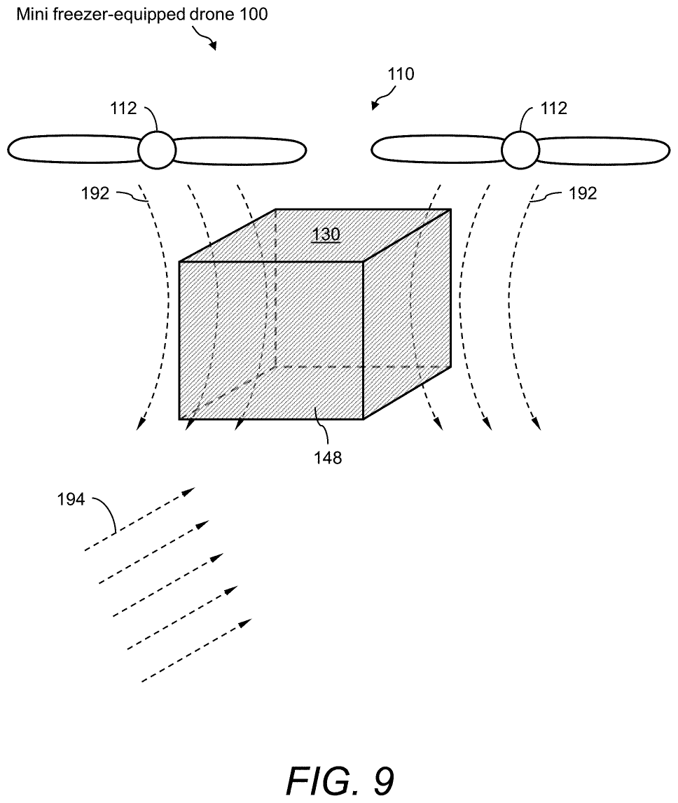

Referring now to FIG. 9 a perspective view of an example of mini freezer-equipped drone 100 is illustrated including mini freezer box 130 formed using a heat conductive material 148, in accordance with an embodiment of the disclosure. For example, the side panels, the top panel, and/or the bottom panel of mini freezer box 130 may be formed of heat conductive material 148. Heat conductive material 148 may be, for example, copper, aluminum, and the like. In this way, mini freezer box 130 may provide a heat conductive enclosure to assist in removing heat from the hot side of the TECs 134 (not shown). As will be appreciated, any number of panels may be formed from head conductive material.

Additionally, the entire surface of mini freezer box 130 and other available surfaces on drone 110, such as the landing legs, frame, and props, may be made from thermally conductive materials and connected to the hot side of TECs 134. Cooling surface area is maximized without adding additional weight or requiring additional battery energy in this case and heat removal only relies on the propeller air drafts 192 and winds 194 (e.g., headwinds or tailwinds).

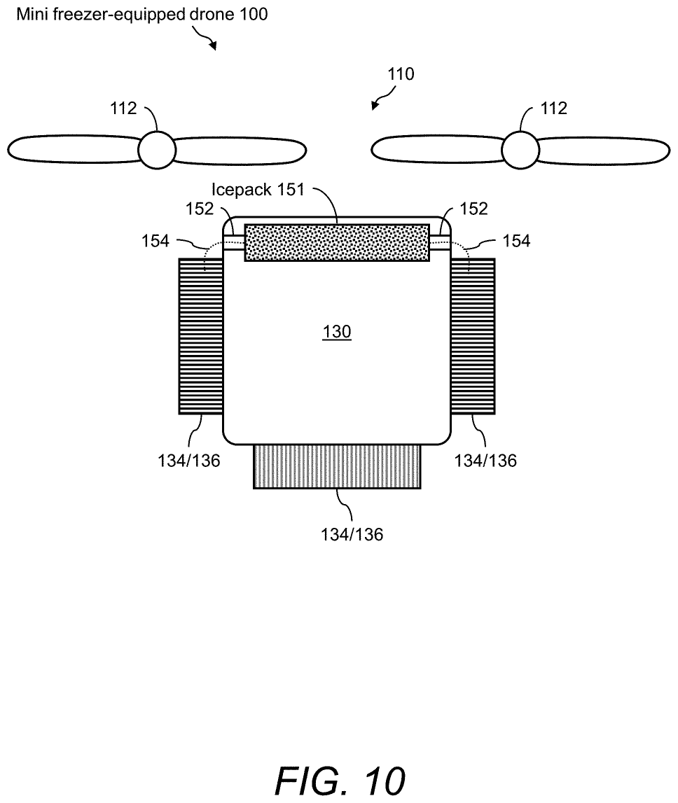

Referring now to FIG. 10 is a side view of an example of mini freezer-equipped drone 100 including both active cooling mechanisms 132 and passive cooling mechanisms 150, in accordance with an embodiment of the disclosure. In this example, a top portion of mini freezer box 130 may be designed to hold one or more icepacks 151. Additionally, drip ports 152 may be provided through the walls of mini freezer box 130 and at icepacks 151. In this example, as ice of icepacks 151 melts, liquid coolant 154 (e.g., cold water) may flow through the drip ports 152 and onto the TEC heatsinks 136 of the TECs 134. In this way, “drip cooling” from icepacks 151 may be used to assist in removing heat from the hot side of the TECs 134.

One method to achieve cooling hot side of TECs 134 is to use icepacks 151 which will serve dual purpose—(1) to help with keeping the payload cool and (2), when it is melted into water, that water (e.g., liquid coolant 154) can be used to enhance cooling the TEC heatsinks 136 on the hot side of TECs 134 through evaporative cooling. Here, water can be dripped or sprayed onto the heat fins of TEC heatsinks 136, which evaporates and removes the heat more efficiently than just air cooling. Again, propeller air drafts 192 and winds 194 (e.g., headwinds or tailwinds) may be used to enhance the evaporation thereby removing heat more efficiently. In addition to vaccines, diluents are sometimes required and such diluents can also be frozen to act as ice packs within the cooling chamber. However, the diluents cannot be dispensed for cooling TEC heatsinks 136 as thawed diluents will be required for vaccines.

Further, icepacks 151 can help keep the temperatures low without active TEC cooling to maintain refrigeration temperatures (from about 2° C. to about 8° C.) although passive cooling alone (e.g., icepacks 151) may not be sufficient to achieve −20° C. In such passive cooling, ice packs 151 may not be required to drip onto heatsinks because there will not be a TEC. Though dry ice can be used to maintain lower temperatures down to −80° C., precisely maintaining −15 C to −25 C or any sub-freezing temperature requires active control (e.g., TECs 134) of the cooling chamber, which is mini freezer box 130. Multiple TECs 134 may be required to provide sufficient cooling down to −20° C. Accordingly, in some instances, temperature can be controlled through the implementation of active cooling and passive cooling in combination.

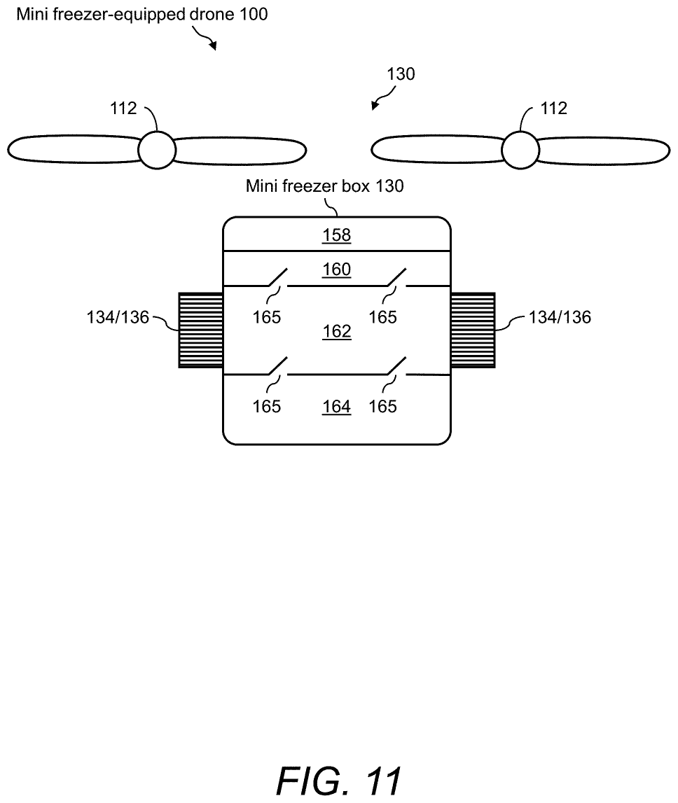

Referring now to FIG. 11 a side view of an example of mini freezer-equipped drone 100 is illustrated including both active cooling mechanisms 132 and passive cooling mechanisms 150 to provide multiple temperature hybrid cooling, in accordance with an embodiment of the disclosure. In this example, mini freezer box 130 may include an arrangement of multiple cooling regions. For example, from top to bottom, a room temperature region 158, then an icepack region 160, then a cooling region 162, and then a dry ice region 164.

For example, room temperature region 158 is exposed to the ambient air surrounding mini freezer box 130 and is therefore at the ambient air temperature. Next, icepack region 160 may hold some amount of ice and is therefore at a temperature of, for example, from about 2° C. to about 8° C. Next, cooling region 162 may include one or more TECs 134 and is therefore at a temperature of, for example, from about −25° C. to about −15° C. or at about −20° C. Next, dry ice region 164 may hold some amount of dry ice and is therefore at a temperature of, for example, about −80° C.

Further, some number of electronically controlled gates 165 (e.g., flow ports) may be provided between icepack region 160 and cooling region 162 that allow air flow therebetween. Similarly, some number of electronically controlled gates 165 may be provided between cooling region 162 and dry ice region 164 that allow air flow therebetween. In this way, electronically controlled gates 165 may be used to assist in controlling the overall temperature within mini freezer box 130.

In some instances, multiple chambers are setup within mini freezer box 130 to carry payloads that have different temperature requirements, such as room temperature, 2-8° C., −8° C., −20° C., and −80° C.

2° C. to 8° C. may be possible with passive cooling by ice packs in icepack region 160 though there may a danger of freezing the payload without active cooling.

−20° C. may be achievable with a single or multiple TECs 134 in cooling region 162. −80° C. may be achievable by either dry ice and/or active TECs 134. Further, the electronically controlled and thermally insulated gates 165 may be used to open between chambers so that higher temperatures can be controlled from a chamber that is actively controlled to the lowest required temperatures. For example, a conduit can be controlled between the −20° C. cooling region 162, which is actively cooled with TECs 134 and the 2-8° C. icepack region 160, which is indirectly controlled by the electronically controlled gates 165. In order to prolong the thermal stability of dry ice at −80 C, cooling region 164 can also be fitted with TECs 134 to pump cooling into the chamber.

In some other embodiments, the chamber of mini freezer box 130 may be designed as concentric cylinders or spheres or any other containers with the coldest chamber at the center and other chambers with increasing temperature requirements radially placed in outer chambers.

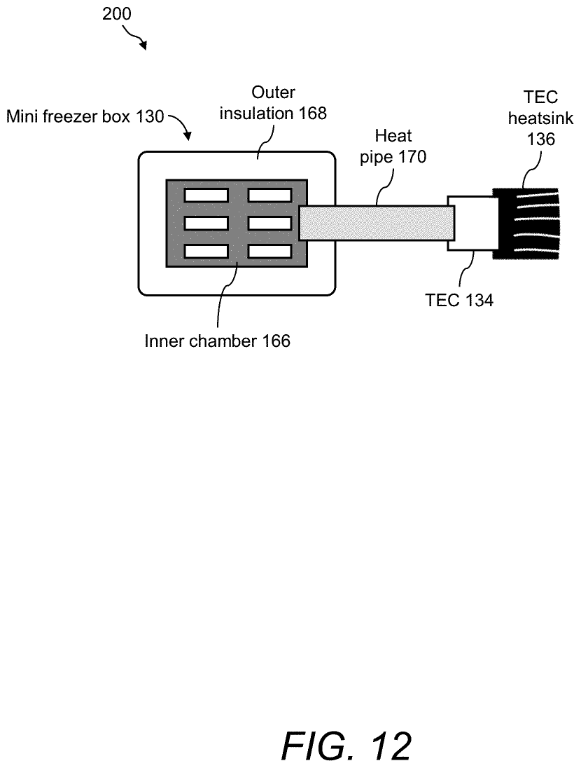

Referring now to FIG. 12 a side view of an example of a configuration 200 of mini freezer box 130 illustrated including a heat pipe, in accordance with an embodiment of the disclosure. In configuration 200, mini freezer box 130 may include an inner chamber 166 enclosed in outer insulation 168 and wherein inner chamber 166 may hold vials 190 (not shown). Then, a heat pipe 170 may be provided between inner chamber 166 and TEC 134 with its TEC heatsink 136. In this example, heat pipe 170 may be used to increase the thermal insulation and/or thermal gradient between or across the hot side and cold side of TEC 134 so that when the TEC is cycled to OFF position heat does not easily flow back into the cold region. It should be noted that the TECs need not be continuously turned ON to provide cooling in the chamber because a certain temperature range needs to be maintained and closed loop feedback can be used to turn the TEC ON and OFF to maintain the desired temperature zone. Moreover, continuously keeping the TEC ON will lead to higher power consumption and a larger battery.

In some instances, heat pipe 170 is connected between the cold side of TEC 134 and inner chamber 166 of mini freezer box 130. When TEC 134 is turned off, heat from TEC heatsink 136 can easily leak onto the cold side because TECs are normally very thin. This helps keep the heat from the hot side of TEC 134 from leaking into inner chamber 166 of mini freezer box 130. To control losses of the cooling temperature, heat pipe 170 will be insulated. To keep the weight low, a planar heat pipe 170 can be used. Further, TEC heatsink 136 may be cooled by all the methods described herein.

Referring now again to FIG. 1 through FIG. 12, the size and/or volume of mini freezer box 130 may vary depending on one the size and/or load capabilities of drone 110 and/or depending on the amount/weight of biological materials to be transported. In one example, mini freezer box 130 may be a 2-inch by 2-inch by 3-inch (i.e., 12 cubic inch) box. A thermally resistant and lightweight box formed of polystyrene foam/Styrofoam/expanded polystyrene/extruded polystyrene insulator to keep the contents cool. Further, in one example, drone 110 may weigh about 2.6 pounds and with GPS and autonomous flying capabilities. The weight of mini freezer box 130 (including TECs 134 and other hardware) may be about 1.3 pounds. In mini freezer-equipped drone 100, mini freezer box 130 may be optimized for weight, because weight is an important factor that may determine its flight duration.

In an example of mini freezer box 130 including two TECs 134 and capable to cool down to or achieve a temperature of about −20° C., mini freezer box 130 may weigh about 0.7 ounces, two TECs 134 (e.g., two TECs 12706) may weigh about 1.6 ounces, two TEC heatsinks 136 may weigh about 3 ounces, TEC battery power 144 (e.g., 6 mAh battery) may weigh about 14.8 ounces, and a payload of 100 vaccines may weigh about 5.26 ounces. Bringing the total weight of mini freezer box 130 and its contents in this example to about 1.6 pounds (about 25.4 ounces).

In an example of mini freezer box 130 including one TEC 134 and capable to cool down to or achieve a temperature of 2° C. to 8° C., mini freezer box 130 may weigh about 0.7 ounces, one TEC 134 (e.g., one TEC 12706) may weigh about 0.8 ounces, one TEC heatsink 136 may weigh about 1.5 ounces, TEC battery power 144 (e.g., 6 mAh battery) may weigh about 8.75 ounces, and a payload of 100 vaccines may weigh about 5.26 ounces. Bringing the total weight of mini freezer box 130 and its contents in this example to about 1.0 pounds (about 16.0 ounces).

Further, with respect to one or more vaccine vials weight calculation, a 2 mL glass vial weighs about 7 g. Each Pfizer vaccine multidose vial (MDV), for example, has 0.45 mL frozen liquid, which is then reconstituted with 1.8 mL 0.9% NaCl solution, which does not need to be stored at ultralow temperatures. Each 2 mL vial with 0.45 mL liquid therefore weighs 7.45 g (0.45 mL water weighs 0.45 g). Each 2 mL MDV can provide 5 doses after dilution. Therefore, for 100 doses, 20 such MDVs are required, which is 149 g (0.33 lbs). Therefore, 1 pound for vials will provide 300 doses. Each 2 mL MDV vial has dimensions of 16 mm in diameter and 35 mm in height. Therefore, 20 such MDVs occupy about 11 cu. inches. A fridge capacity of 12 cubic inches is sufficient for 100 doses of vaccine.

Further, with respect to the drone motor thrust vs current draw, drone 110 may have four motors (e.g., Emax MT2213-935 KV 2212). In this example, the thrust at a current draw of 9.6 A is 670 g. Therefore, the combined thrust for all the four motors together is 2,680 g or −6 pounds. The weight of drone 110 is 2.7 pounds without mini freezer box 130, but includes the frame, motors, ESCs, RPi, Navio 2, GPS, 3,000 mAh battery, and all electronics. Therefore, drone 110 may be capable or configured to lift a weight of about 3 pounds on full charge at its highest current draw in addition to its own weight of 3 pounds. In this example, a design constraint of 3 pounds may be set for mini freezer box 130 including its battery and payload.

Further, with respect to the weight of the battery, the required battery weight is directly proportional to the charge capacity of the battery therefore it is ideal to choose a battery with just enough capacity to lift mini freezer-equipped drone 100 and power the TEC 134.

Referring still to FIG. 1 through FIG. 12, in another example, the walls of mini freezer box 130 may be XPS (extruded polystyrene) because of its good heat resistance. The parameters may be as follows.

Outer dimensions of each of the 6 walls of mini freezer box 130 is 4.5 inches by 4.5 inches with a thickness of 0.75 inches.

Inner dimensions of mini freezer box 130 is 3 inches by 3 inches with a height of 2.25 inches because there may be an additional 0.75-inch block of XPS added to the top lid to ensure a snug fit when the lid is closed.

The weight of this mini freezer box 130 with glue plus TEC 134 and TEC heatsink 135 may be about 3 ounces (0.2 pounds).

XPS material is 0.75 inches (0.01905 m) thick and has an R-value of 4 h·ft2·° F./Btu, which can be converted to SI units with the following conversion factor.

$$\begin{matrix}RSI ( SI ) = R - value ( U . S . ) \times 0.1761101838 \\ = 4 \times 0.1761101838 \\ = 0.704 m 2 \cdot K / W\end{matrix}$$

$$\begin{matrix}k - value ( thermal conductivity , = thickness ( m ) / R - value ( SI ) \\ which is independent of thickness , \\ may be calculated as , \\ = 0.01905 m / 0.704 m 2 \cdot K / W \\ = 0.027 W / m \cdot K\end{matrix}$$

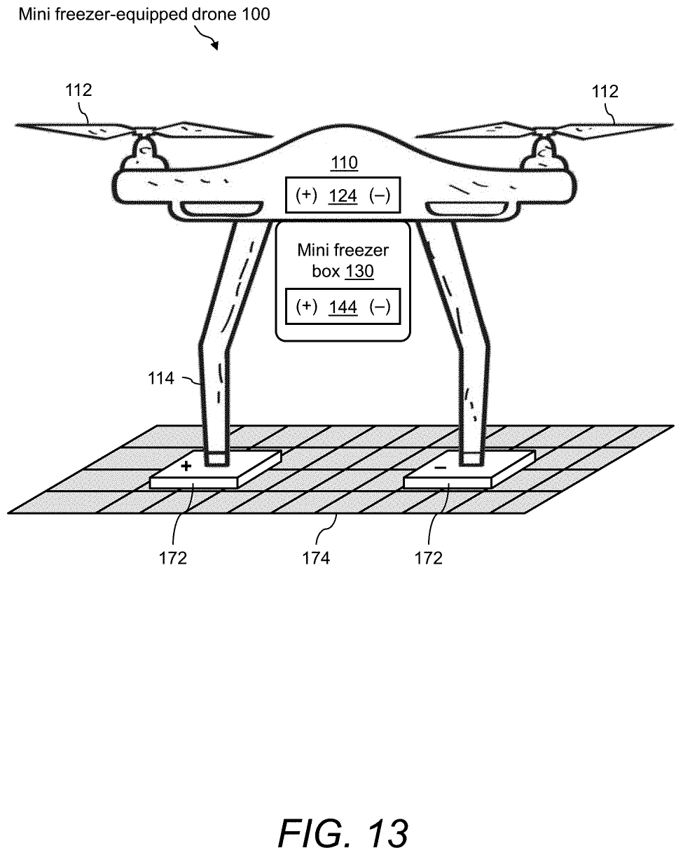

Referring now to FIG. 13 a side view of an example of mini freezer-equipped drone 100 is illustrated including mechanisms for self-charging, in accordance with an embodiment of the disclosure. For example, a negative (−) charging pad 172 may be provided at the tip of one leg of landing gear 114 of drone 110. The negative (−) charging pad 172 may be electrically connected to the negative (−) side of battery power 124 of drone 110 and TEC battery power 144 of mini freezer box 130. Similarly, a positive (+) charging pad 172 may be provided at the tip of another leg of landing gear 114 of drone 110. The positive (+) charging pad 172 may be electrically connected to the positive (+) side of battery power 124 of drone 110 and TEC battery power 144 of mini freezer box 130.

In this example, mini freezer-equipped drone 100 may further include a solar panel 174 that may be affixed and electrically connected to the charging pads 172. In this way, mini freezer-equipped drone 100 may be self-charging.

More specifically, in many low resource settings, electricity is not reliable therefore a solar panel would be highly desirable. Solar panel 174 may have landing pads (not shown) with unique barcodes and GPS location, which will be identified by drone 110 (through multiple means e.g., camera) to autonomously land. Charging pads 172 may be magnetically aligned with the landing pads of solar panel 174. Charging pads 172 of drone 110 are electrically conductive (either with wires wrapped around the feet or wires running within the feet) so that battery power 124 of drone 110 and TEC battery power 144 of mini freezer box 130 may charge as soon as it lands. Solar panel 174 may provide the amperage required to charge the batteries within a few hours.

A drone freezer (or mini freezer) can also have an independent battery so that the flight is not disrupted if there are any power fluctuations or uncontrolled battery drain for active cooling. However, there can be a data link between the flight control board and the freezer electronics to ensure the active cooling is turned off to avoid a crash. With cellular coverage or other telemetry or direct communication with the drone, trip data can be logged to have constant surveillance of the temperature of the fridge and report to the base station in case of excessive battery drain, monitor, report and control the vibration (e.g., the lipid structure of mRNA vaccines can be kept intact). The battery level can also be monitored for active cooling during flight.

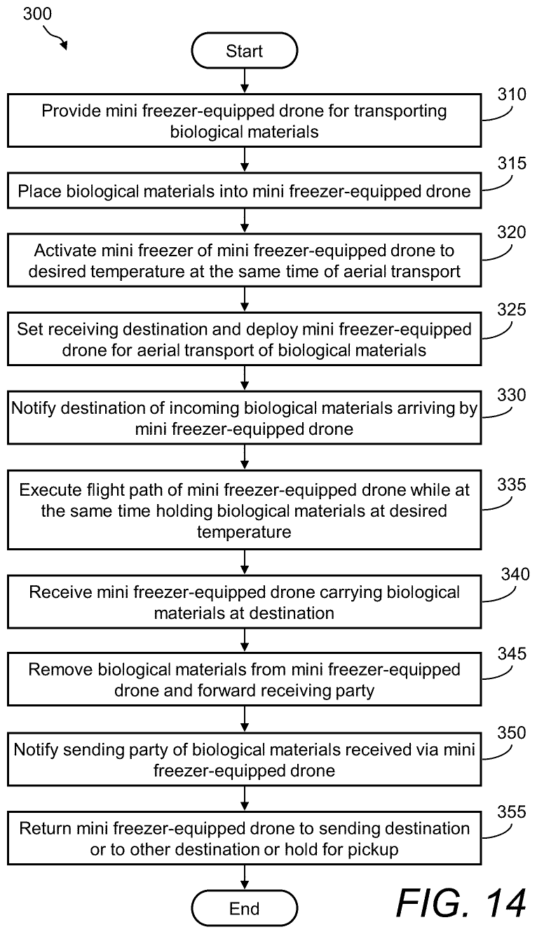

Referring now to FIG. 14 a flow diagram of an example method 300 of using mini freezer-equipped drone 100 for transporting biological materials is depicted, in accordance with an embodiment of the disclosure. Method 300 may include, but is not limited to, the following steps.

At a step 310, a mini freezer-equipped drone for transporting biological materials is provided. For example, mini freezer-equipped drone 100 as described hereinabove with reference to FIG. 1 through FIG. 13 is provided for transporting biological materials, such as, but not limited to, vaccines, blood samples, urine samples, saliva samples, nasal samples, bodily fluids, tissue samples, and the like.

At a step 315, the biological materials are placed into the mini freezer-equipped drone. For example, a user places biological materials, such as multiple vials of vaccine, into mini freezer box 130 of mini freezer-equipped drone 100.

At a step 320, the mini freezer of the mini freezer-equipped drone is activated to some desired temperature for holding biological materials at the same time of aerial transport. For example, the user may use radio transmitter 105 or some other smart device to activate mini freezer box 130 of mini freezer-equipped drone 100. For example, to activate TECs 134 of mini freezer box 130. In one example, mini freezer box 130 may be activated to a temperature of, for example, from about 2° C. to about 8° C. In another example, mini freezer box 130 may be activated to a temperature of, for example, from about −25° C. to about −15° C. or at about −20° C. In this way, biological materials may be held at a desired temperature at the same time that mini freezer-equipped drone 100 is in flight.

At a step 325, the receiving destination is set and the mini freezer-equipped drone is deployed for aerial transport of the biological materials. For example, the user may use radio transmitter 105 or some other smart device to program the location (e.g., street address, GPS coordinates) of the receiving destination into mini freezer-equipped drone 100. Then, the user may use radio transmitter 105 or some other smart device to initiate or launch mini freezer-equipped drone 100, which is carrying the biological materials, into flight.

At a step 330, the target destination is notified of the incoming biological materials arriving by mini freezer-equipped drone. For example, the user may use radio transmitter 105 or some other smart device to notify the target destination (e.g., hospital, lab, clinic, health care center, consumer) that certain biological materials, temperature-sensitive materials, or perishables are soon to be or are already in transit by mini freezer-equipped drone 100. An estimated time of arrival may be given to the receiving party.

At a step 335, the flight path of the mini freezer-equipped drone is executed while at the same time the biological materials are held at a desired temperature. In one example, the flight path of mini freezer-equipped drone 100 is executed automatically based on the target location information programed in method step 325. In another example, the flight path of mini freezer-equipped drone 100 is guided manually by the sender or the receiver using an onboard camera. Further, in this step, at the same time that the flight path is executing, the biological materials are held at a desired temperature within mini freezer box 130.

At a step 340, the mini freezer-equipped drone carrying the biological materials is received at the target destination. For example, mini freezer-equipped drone 100 carrying the biological materials is received at the target destination (e.g., hospital, lab, clinic). Further, in this step, mini freezer-equipped drone 100 may be manually guided to a safe landing by the sender navigating via a drone onboard camera or just programmed to land autonomously using the onboard sensors (e.g., gyroscope, GPS, LIDAR).

At a step 345, the biological materials are removed from the mini freezer-equipped drone and forwarded on to a receiving party. For example, a person at the destination (e.g., hospital, lab, clinic) removes the biological materials from mini freezer box 130 of mini freezer-equipped drone 100. Then, the receiving party forwards the biological materials on to a receiving party.

At a step 350, the sender is notified of the biological materials being received via the mini freezer-equipped drone. For example, the receiving party notifies the sending party that the biological materials have been received via mini freezer-equipped drone 100. This notification may occur using any communications means. In one example, the sending party receives notification via a mobile app on a smartphone or any smart device.

At a step 355, the mini freezer-equipped drone is returned to the sending destination or to any other destination or held for pickup. For example, mini freezer-equipped drone 100 is returned (by flight) to the sending destination (which may be automatically stored when deployed) or to any other destination or held for pickup.

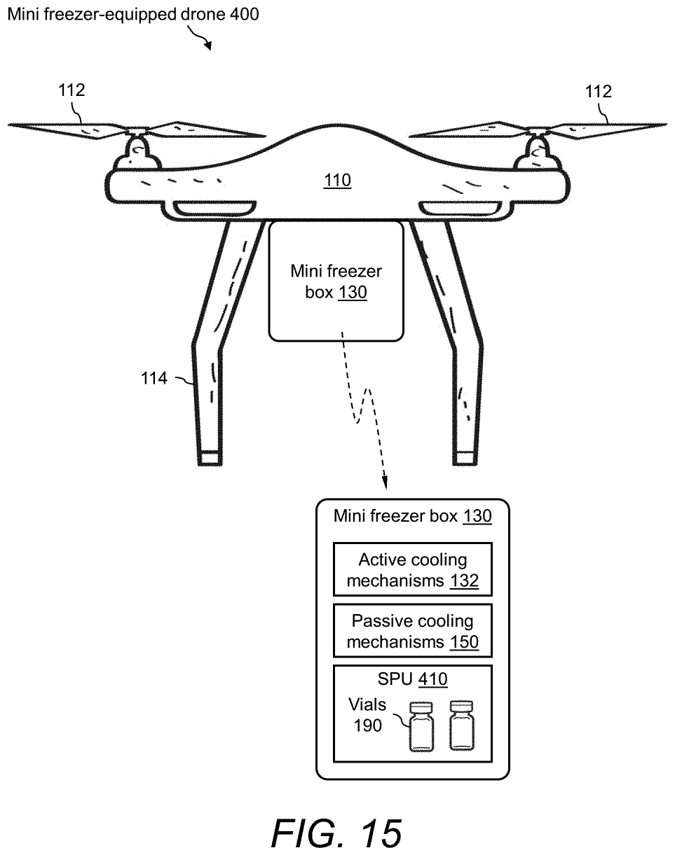

Referring now to FIG. 15 a side view of an example of a mini freezer-equipped drone 400 illustrated for transporting biological materials and wherein mini freezer box 130 may include a sample processing unit (SPU) 410, in accordance with an embodiment of the disclosure.

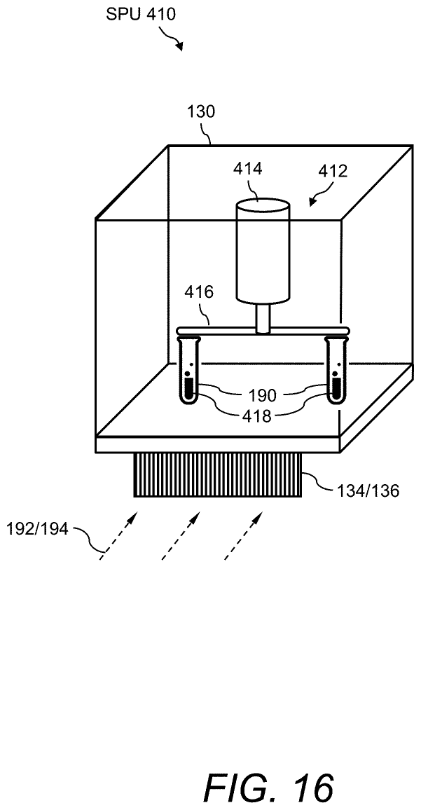

Referring now to FIG. 16 a perspective view of an example of SPU 410 for use in mini freezer-equipped drone 100 is for both transporting and processing biological materials is illustrated, in accordance with an embodiment of the disclosure. In this example, SPU 410 may include mini freezer box 130 (e.g., the temperature control device) as described above in FIG. 1 through FIG. 14. Mini freezer box 130 provides a temperature-controlled chamber of SPU 410 that is suitable for processing biological materials.

In one example, a centrifuge 412 is arranged inside mini freezer box 130 for processing biological materials that may be held, for example, in vials 190. Examples of biological materials may include, but are not limited to, vaccines, blood samples, urine samples, saliva samples, nasal samples, bodily fluids, tissue samples, and the like.

In this example, centrifuge 412 may include a motor 414 whose shaft is coupled to an arm (or bar) 416 that has vials 190 for holding biological materials 418. Arm 416 may be arranged substantially horizontally and hold one vial 190 on each end. Accordingly, in this example, motor 414 may be used to spin up to two biological materials 418 and/or dummy liquids or weights held on arm 416.

For best stability, motor 414 of centrifuge 412 may be arranged at substantially the center of the body of drone 110 and with its axis of rotation substantially vertical. In one example, motor 414 may have about the same specifications as the propeller motors, though that may not be a requirement. In another example, centrifuge 412 may be gyro-stabilized when mini freezer-equipped drone 400 is not horizontal but has a pitch, yaw, or roll.

In one example, a sample tube (e.g., containing blood) may be loaded into each of the two vials 190. In another example, only one vial 190 is loaded with a sample tube (e.g., containing blood) and then to balance centrifuge 412 another equal weight may be placed in the other vial 190. Motor 414 of centrifuge 412 then spins arm 416 to generate centrifugal forces to separate the components of the sample while mini freezer-equipped drone 400 is in flight or the process can commence even before mini freezer-equipped drone 400 takes off or after it lands. All the while, the one or more biological materials 418 are maintained at a certain temperature while being centrifuged. In one example, one or more blood samples are maintained at a certain temperature while being centrifuged to prepare plasma or serum.

In one example, SPU 410 may be the SPU described in reference to U.S. Patent Pub. No. 20210172930, entitled “Sample Processing Unit (SPU)-Equipped Drone for Transporting and Processing Biological Materials and Method of Using Same,” filed on Dec. 7, 2020; the entire disclosure of which is incorporated herein by reference.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the disclosure will be apparent to the skilled person without departing from the scope and spirit of the disclosure. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims. Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A system for transporting a temperature-sensitive payload, comprising:
a drone comprising a drone body and one or more propellers; and
a freezer connected to the drone body and configured to contain a payload.

2. The system of claim 1, wherein the freezer is configured to maintain an internal temperature of down to −20° C.

3. The system of claim 2, wherein the freezer is configured to maintain the internal temperature through active temperature control.

4. The system of claim 3, further comprising a temperature measurement device configured to provide active temperature feedback of the freezer.

5. The system of claim 1, further comprising one or more thermoelectric devices disposed on at least one side of the freezer.

6. The system of claim 5, wherein the thermoelectric device is a thermoelectric heatsink.

7. The system of claim 5, wherein the thermoelectric device is a thermoelectric cooling fan.

8. The system of claim 5, wherein the thermoelectric device is a thermally conductive wire.

9. The system of claim 1, further comprising an active cooling mechanism.

10. The system of claim 1, further comprising a passive cooling mechanism.

11. The system of claim 1, wherein the surface area of one or more sides of the freezer is maximized.

12. The system of claim 10, wherein the passive cooling mechanism comprises one or more ice packs.

13. The system of claim 1, further comprising a battery.

14. The system of claim 13, wherein the battery is selected based on at least one of desired temperature, flight duration, and weight carrying capacity.

15. A method for transporting a temperature-sensitive payload using a system of claim 1.
